(19) United States
(12) Patent Application Publication
(10) Pub. No.: US 2011/0179001 A1
(43) Pub. Date: Jul. 21, 2011

(54) ANNOTATING MEDIA CONTENT WITH RELATED INFORMATION

(75) Inventors: Brett L. Lindsley, Wheaton, IL (US); Bhavan R. Gandhi, Vernon Hills, IL (US)

(73) Assignee: MOTOROLA, INC., Schaumburg, IL (US)

(21) Appl. No.: 13/011,831

(22) Filed: Jan. 21, 2011

Related U.S. Application Data
(62) Division of application No. 11/467,974, filed on Aug. 29, 2006.

(51) Int. Cl. G06F 17/30

(52) U.S. Cl. 707/705; 707/803; 707/E17.143; 707/E17.095

(57) ABSTRACT

A method 300 for retrieving media content (120). The method can include receiving metadata (118) associated with a first media file, receiving the first media file, processing at least the metadata to identify at least a second media file (124) likely to be of interest to a user, and automatically downloading the second media file. Processing the metadata can include identifying at least one parameter contained in the metadata and/or the first media file that correlates to the second media file. Metadata (122) also associated with the second media file also can be downloaded.

### CROSS REFERENCES TO RELATED APPLICATIONS

This application is a divisional patent application of U.S. patent application Ser. No. 11/467,974, filed Aug. 29, 2006, which is herein incorporated by reference.

### BACKGROUND OF THE INVENTION

1. Field of the Invention

The present invention generally relates to communications and, more particularly, to communication of media content.

2. Background of the Invention

Playback and storage of digitized media content downloaded over a communications network, such as the Internet, has become popular in recent years. Indeed, in addition to personal computers, a variety of other media devices, for instance personal media players and mobile stations, have been developed to access and present digitized media content. One mechanism used by such devices to access the media content is to download the content from web servers by accessing information feeds on the web servers using known uniform resource identifiers (URIs).

To facilitate the download of media content that is of interest to a user, media devices often access an aggregator. An aggregator can establish a unique information space for a user and subscribe to one or more information feeds identified by the user. At user determined intervals the aggregator can access the information feeds to receive metadata for subscription content that is newly available or that has changed. When newly available or changed media content is identified, the aggregator usually downloads such content to the user's information space. From the information space, the media content can be transferred to a media player for playback.

Unfortunately, media content downloaded by the aggregator is, in general, limited to content to which the user has subscribed. Thus, other media content of which the user has not specifically requested, but nevertheless may be of interest to the user, may be ignored by the aggregator. In consequence, the user may miss the opportunity to experience such content.

### SUMMARY OF THE INVENTION

The present invention relates to a method for retrieving media content. The method can include receiving metadata associated with a first media file, receiving the first media file, processing at least the metadata to identify at least a second media file likely to be of interest to a user, and automatically downloading the second media file. Processing the metadata can include identifying at least one parameter contained in the metadata that correlates to the second media file. The method further can include processing the first media file to identify the second media file. Processing the first media file can include rendering content contained in the first media file and identifying at least one parameter contained in the rendered content that correlates to the second media file. Processing the metadata also can include processing metadata embedded within content in the first media file.

A user preference also can be processed to identify the second media file. The method further can include communicating the first media file and the second media file from an aggregator to a media device. The method also can include receiving metadata associated with the second media file. The metadata associated with the first media file and the metadata associated with the second media file can be communicated to a media device. The method also can include organizing the received metadata for presentation and navigation using a metadata browser.

The present invention also relates to an electronic device that includes an aggregator. The aggregator can receive metadata associated with a first media file, receive the first media file, process at least the metadata to identify at least a second media file likely to be of interest to a user, and automatically download the second media file. The aggregator also can identify at least one parameter contained in the metadata that correlates to the second media file. Further, the aggregator can process the first media file to identify the second media file.

The electronic device also can include a media player that renders content contained in the first media file, wherein the aggregator identifies at least one parameter contained in the rendered content that correlates to the second media file. The aggregator can process metadata embedded within content in the first media file. The aggregator also can process a user preference to identify the second media file. The aggregator can communicate the first media file and the second media file to a media device. The aggregator also can organize the received metadata for presentation and navigation using a metadata browser.

The present invention also relates to a media device. The media device can include a datastore on which content metadata and annotation metadata is stored. The media device also can include a metadata browser that browses the content metadata and annotation metadata, and associates content metadata items with correlating annotation metadata items. Further, responsive to a user selection of at least one of the annotation metadata items in the metadata browser, the media device can load an annotation content media file on a media player. Responsive to a user selection of at least one of the content metadata items in the metadata browser, the media device can load a channel content media file on the device player.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 depicts a block diagram of a media device that is useful for understanding the present invention; and

FIG. 3 is a flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to an aggregator that retrieves media content and associated metadata, and identifies additional media content that may be of interest to a user. The aggregator then can automatically download the additional media content, as well as associated metadata, and make the additional media content and metadata available to the user. For instance, the aggregator can transfer the additional media content and metadata to a media device along with the originally accessed media content and metadata. Notably, the aggregator can be instantiated on a client, such as a computer or mobile station. Accordingly, processing to identify the additional media content can be performed on the client, thereby insuring virtually infinite scalability without significantly increasing the burden on servers that provide the media content.

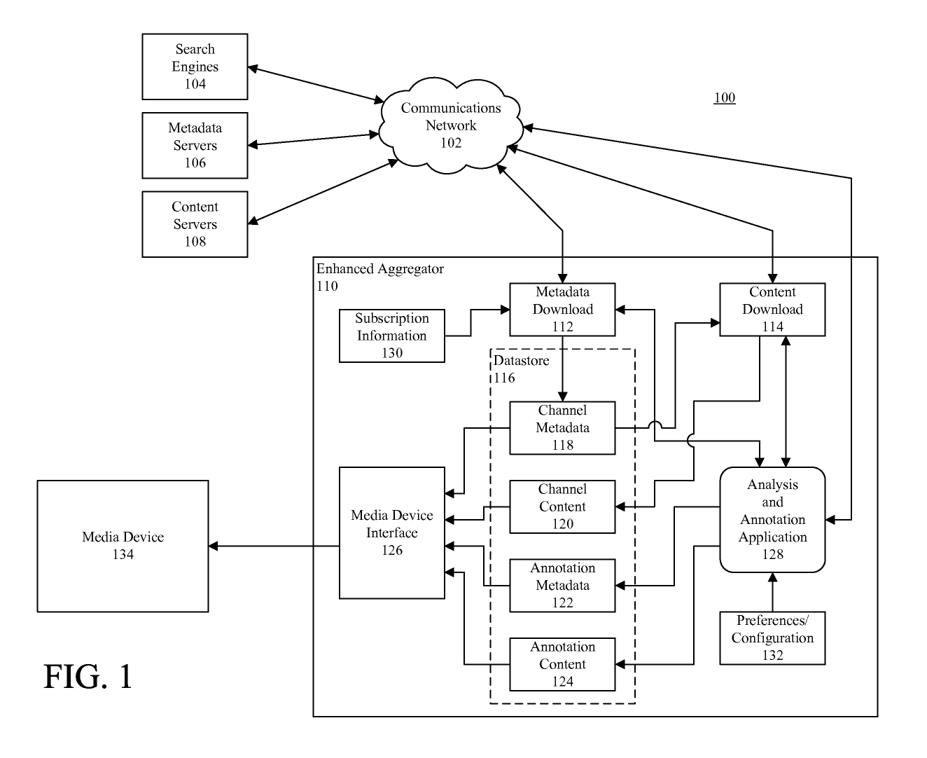

FIG. 1 depicts a communications system 100 that is useful for understanding the present invention. The communications system 100 can include a communications network 102, which can comprise, for example, the Internet, the World Wide Web, a wide area network (WAN), a local area network (LAN), a cellular communications network, a dispatch communications network, an interconnect communications network, a public switched telephone network (PSTN), and/or any other networks or systems over which communication signals can be propagated. In that regard, the communications network can include wired and/or wireless communication links.

The communications system 100 also can include one or more servers communicatively linked to the communications network 102. For example, the communications network can include one or more search engines 104, one or more metadata servers 106 and one or more content servers 108. As one skilled in the art will appreciate, the servers 104, 106, 108 can be instantiated on a single processing device, such as a computer, or among a plurality of processing devices. Moreover, each of the individual servers 104, 106, 108 also may be instantiated among a plurality of processing devices.

The communications system 100 also can include an enhanced aggregator (hereinafter “aggregator”) 110. The aggregator 110 can be instantiated on an electronic device, for example a computer, a mobile station, a personal digital assistant, a media player, or any other device that may be communicatively linked to the communications network 102 and download media content. The aggregator 110 can download media files containing media content from the content servers 108 and download metadata correlating to the media content from the metadata servers 106. The aggregator 110 then can communicate the media content and metadata to a media device 134.

The aggregator can include a metadata download module 112 and a content download module 114. The metadata download module 112 can communicate with the metadata servers 106 via the communications network 102. Similarly, the content download module 114 can communicate with the content servers 108 via the communications network 102. The download modules 112, 114 can communicate in accordance with one or more suitable communications protocols. Examples of such protocols can include, but are not limited to, TCP/IP, IEEE 802 wireless communications, WPA, WPA2, GSM, TDMA, CDMA, WCDMA, direct wireless communication, HTTP and FTP. Suitable hardware (not shown), such as a network adapter or transceiver, can be provided by a device on which the aggregator 110 is instantiated to support such communications.

The aggregator also can include a datastore 116 in which channel metadata 118, channel content 120, annotation metadata 122 and annotation content 124 can be stored. The datastore can include, for example, one or more folders or directories which are accessible to the aggregator 110. As will be described herein in further detail, the annotation metadata 122 and annotation content 124 can be metadata and media content to which the user has not specifically subscribed, but may be of interest to the user and can be automatically downloaded by the aggregator.

The aggregator 110 also can include a media device interface 126 which communicates data, such as the channel metadata 118, channel content 120, annotation metadata 122 and annotation content 124, to a media device 134. In an arrangement in which the media device 134 is not contained on the same device on which the aggregator 110 is instantiated, the media device interface 126 can communicate with the media device 134 via a universal serial bus (USB), an IEEE-1394 (FireWire) bus, a serial port, a parallel port, an infrared port, direct wireless communications (e.g. Bluetooth or ZigBee), or communicate with the media device 134 in any other suitable manner.

The aggregator 110 further can include an analysis and annotation application 128 that analyzes downloaded metadata and media content to identify additional media content that may be of interest to a user. For example, if the channel content includes music files, the analysis and annotation application 128 can identify news articles and pictures pertaining to performers of the music, identify web sites related to the music, identify other music of the same genre, and so on. The analysis and annotation application 128 can identify the additional media content by formulating a search query based on parameters identified in the channel metadata 118, parameters identified in metadata embedded within the channel content 120 and/or other parameters of the channel content 120. The analysis and annotation application 128 then can communicate the search query to the search engines 104 and/or metadata servers 106, and initiate download of media content and/or metadata identified by the search engines 104 and/or metadata servers 106. Such techniques are described in U.S. patent application Ser. No. 11/324,854 filed Jan. 4, 2006, which is herein incorporated by reference in its entirety. In the case of conflict, the present specification, including definitions, will control.

In addition, the analysis and annotation application 128 also can organize the new media content and/or metadata before annotating it to the channel content 120 and channel metadata 118. For example, the new media content and/or metadata can be organized to facilitate presentation and navigation using a metadata browser. The organization can include, for example, time ordering the new content, ordering the content by strength of relationships with the channel content 120 (e.g. such as similar keywords), or organizing the new content in any other suitable manner.

In one arrangement, the analysis and annotation application 128 can generate additional metadata that describes the relationship of the new media content and/or new metadata to the channel content 120 and channel metadata 118. Such metadata also can be processed when presenting the new metadata and/or channel metadata 118 in a metadata browser, and can be used to present the content/metadata in a logical manner. The newly downloaded and newly created metadata can be stored as annotation metadata 122. Similarly, the newly downloaded channel content can be stored as annotation content 124.

In operation, the metadata download module 112 can receive subscription information 130 for media content to which a user has subscribed and, typically at given intervals, send requests to the metadata server 106 for associated metadata. In response, the metadata server 106 can provide the channel metadata 118 to the metadata download module 112. The download module 112 can store the channel metadata 118 in the datastore 116. In addition, the channel metadata 118 also can be forwarded to the analysis and annotation application 128. Alternatively, the metadata download module 112 can communicate a pointer to the analysis and annotation application 128 identifying the location of the channel metadata 118 in the datastore 116.

In response to the channel metadata 118 being downloaded, the content download module 114 can generate a message to the content server 108 requesting the channel content 120 identified by the channel metadata 118. The channel content 120 also can be stored to the datastore 116 and made available to the analysis and annotation application 128.

As noted, the analysis and annotation application 128 can process the channel metadata 118 and channel content 120 to select additional metadata 122 and content 124. Such additional metadata 122 and content 124 may be annotated to the channel metadata 118 and channel content 120. While processing the channel metadata 118 and channel content 120, the analysis and annotation application 128 can identify parameters contained therein, as well as relationships among different media files contained in the channel content 120. For example, if the channel content 120 comprises a plurality of music files from the same genre, such genre can be identified. In another arrangement, the analysis and annotation application 128 can communicate with a media player, for instance a media player contained within the media device 134, to render the channel content 120. Further, parameters in the rendered channel content can be identified by the analysis and annotation application 128.

The analysis and annotation application 128 then can generate a query for additional content that is based on the identified parameters and communicate the query to one or more of the search engines 104. In one arrangement, the analysis and annotation application 128 can formulate the query in accordance with user preferences and/or configuration settings 132. For instance, if the user preferences/configuration settings 132 indicate that the user would like to receive news articles related to the channel content 120, the query can specifically request news articles. The preferences/configuration settings 132 also can indicate the types of media content which may be presented with the media device 134, and the query can limit content searches to such media types. Examples of the types include, but are not limited to, audio information, video information, pictures, photographs and text. Still, any other desired form of information can be searched.

In response to the query, the search engines 104 can identify other media content and metadata that match the query parameters, and provide a listing of such content and metadata, along with corresponding uniform resource identifiers (URIs), to the analysis and annotation application 128. The analysis and annotation application 128 can process the listing to select media content likely to be of interest to a user of the media device 134. The analysis and annotation application 128 then can download the media content and corresponding metadata, if available, using the URIs. In one arrangement, the analysis and annotation application 128 can interface with the content download module 114 and/or the metadata download module 112 to perform the downloads.

Once downloaded, the additional media content can be stored as annotation content 124 and the corresponding metadata can be stored as annotation metadata 122. Further, as noted, the analysis and annotation application 128 can organize the annotation content 124 and the annotation metadata 122, and generate additional annotation metadata 122 that describes the relationship of the newly downloaded content/metadata to the channel content/metadata 118, 120. The metadata generated by the analysis and annotation application 128 also can be used to present relationships between the annotation content 124, annotation metadata 122, channel content 120 and channel metadata 118 in an organized manner. When the media device 134 is next synchronized with the aggregator 110 using the media device interface 126, the aggregator can communicate the channel metadata 118, the channel content 120, the annotation metadata 122 and the annotation content 124 to the media device 134.

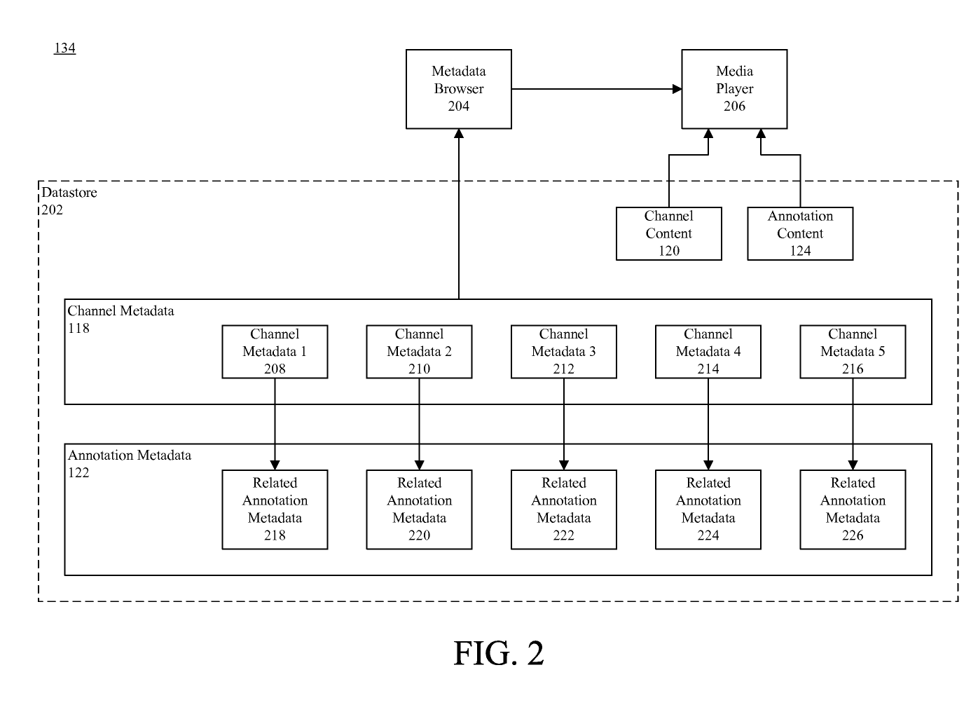

FIG. 2 depicts a block diagram of the media device 134 that is useful for understanding the present invention. The media device 134 can be implemented as hardware, software, or a combination of hardware and software. The media device 134 can be contained on a processing system on which the aggregator 110 is instantiated, or the media device can be a separate device, such as a portable media player.

The media device 134 can include a datastore 202 on which the channel metadata 118, the channel content 120, the annotation metadata 122 and the annotation content 124 is stored. The media device 134 also can include a metadata browser 204, which may be used to browse the channel metadata 118 and annotation metadata 122. The metadata browser 204 can, for instance, comprise a graphical user interface (GUI) that is presented on a display of the media device 134. A user can use the metadata browser 204 to browse the channel metadata 118 and annotation metadata 122 and select which channel content 120 and/or annotation 124 is to be presented by a media player 206 on the media device 134.

The channel metadata 118 can include a plurality of channel metadata items 208, 210, 212, 214, 216, each of which corresponds to a particular media file contained in the channel content 120. Further, the annotation metadata 122 can include annotation metadata items 218, 220, 222, 224, 226. Each of the annotation metadata items 218-226 can correspond to annotation content selected for a particular media file, and can be related to the channel metadata item 208-216 corresponding to the same media file. Advantageously, the channel metadata items 208-216 and annotation metadata items 218-226 can be presented in the metadata browser 204 in a manner that indicates relationships between the channel content 120 and annotation content 124.

For example, assume the channel content 120 contains five media files for which annotation content 124 is available. The channel metadata 208 can correspond to a first of the media files. Further, the annotation metadata item 218 can correspond to annotation content selected for the first media file. When the channel metadata item 208 is presented while the user is browsing the metadata, the annotation metadata item 218 also can be presented. Moreover, the annotation metadata item 218 can be presented in a manner that indicates that it is associated with the channel metadata 208. A user then can select the annotation metadata item 218 to initiate loading of the annotation content 124 media file onto the media player 206 for rendering. Similarly, a user can select the channel metadata item 208 to initiate loading of the channel content 120 media file onto the media player 206 for rendering.

The media device 134 further can include a media player 206 to present, or render, the channel content 120 and the annotation content 124. Media players are known to the skilled artisan. Notably, the metadata may be browsed without requiring that the channel content 120 and annotation content 124 be loaded by the media player 206. Nonetheless, in an arrangement in which parameters are identified in rendered channel content, the media player 206 can be communicatively linked to the analysis and annotation application in the aggregator.

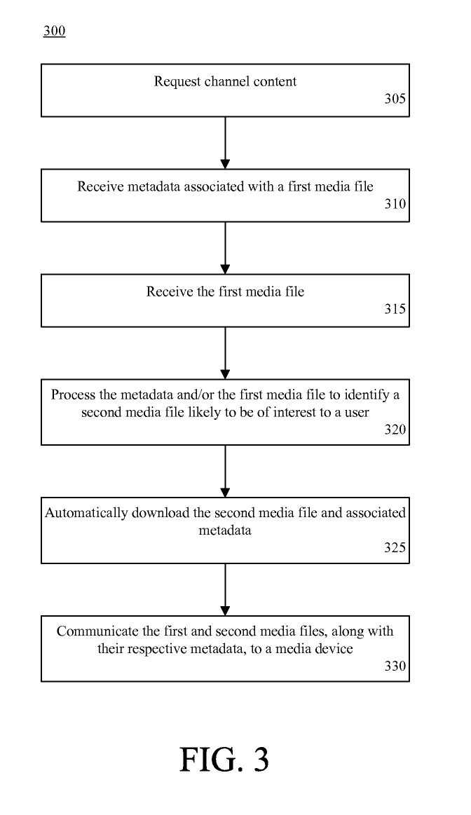

FIG. 3 is a flowchart presenting a method 300 that is useful for understanding the present invention. Beginning at step 305, channel content can be requested by an aggregator. At step 310, metadata associated with a first media file can be received. At step 315, the first media file can be received. Proceeding to step 320, the metadata and/or the first media file can be processed to identify a second media file likely to be of interest to a user. At step 325, the second media file and its associated metadata can be automatically downloaded. Continuing to step 330, the first and second media files, and their respective metadata, can be communicated to a media device.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method for retrieving media content on an electronic device, comprising:
with an aggregator instantiated on the electronic device, the aggregator establishing a unique information space for a user and subscribing to at least one information feed identified by a user, receiving channel metadata associated with a first channel content;
with the aggregator, receiving the first channel content;
with the aggregator, processing at least the channel metadata associated with the first channel content to identify at least a second channel content that will be of interest to the user;
with the aggregator, automatically downloading the second channel content;
with the aggregator, automatically generating annotation metadata that describes a relationship between the first channel content and the second channel content; and
with the aggregator, storing the first channel content, the second channel content, the channel metadata and the annotation metadata to a datastore on the electronic device;
wherein the aggregator comprises a metadata browser that enables a user to browse the channel metadata and the annotation metadata to select for presentation the first and second channel content from the datastore on the electronic device.

2. The method of claim 1, wherein processing the channel metadata associated with the first channel content comprises identifying at least one parameter contained in the channel metadata that correlates to the second channel content.

3. The method of claim 1, further comprising processing the first channel content to identify the second channel content.

4. The method of claim 3, wherein processing the first channel content further comprises:
rendering the first channel content; and
identifying at least one parameter contained in the rendered first channel content that correlates to the second channel content.

5. The method of claim 3, wherein the channel metadata is embedded within the first channel content.

6. The method of claim 1, further comprising processing a user preference to identify the second channel content.

7. The method of claim 1, further comprising communicating the first channel content and the second channel content from the aggregator to a media device.

8. The method of claim 1, further comprising receiving channel metadata associated with the second channel content.

9. The method of claim 8, further comprising communicating the channel metadata associated with the first channel content and the channel metadata associated with the second channel content to a media device.

10. The method of claim 1, further comprising organizing the received channel metadata for presentation and navigation using the metadata browser.

11. An electronic device comprising:
a datastore;
an aggregator instantiated on the electronic device, wherein the aggregator establishes a unique information space for a user, subscribes to at least one information feed identified by the user, receives channel metadata associated with a first channel content, receives the first channel content, processes at least the channel metadata to identify at least a second channel content that will be of interest to the user, automatically downloads the second channel content, automatically generates annotation metadata that describes a relationship between the first channel content and the second channel content, and stores the first channel content, the second channel content, the channel metadata and the annotation metadata to the datastore; and
a metadata browser instantiated on the electronic device, wherein the metadata browser enables a user to browse the channel metadata and the annotation metadata to select for presentation the first and second channel content from the datastore.

12. The electronic device of claim 11, wherein the aggregator identifies at least one parameter contained in the channel metadata that correlates to the second channel content.

13. The electronic device of claim 11, wherein the aggregator processes the first channel content to identify the second channel content.

14. The electronic device of claim 13, further comprising a media player that renders the first channel content, wherein the aggregator identifies at least one parameter contained in the rendered first channel content that correlates to the second channel content.

15. The electronic device of claim 13, wherein the channel metadata is embedded within the first channel content.

16. The electronic device of claim 11, wherein the aggregator processes a user preference to identify the second channel content.

17. The electronic device of claim 11, wherein the aggregator communicates the first channel content and the second channel content to a media device.

18. The electronic device of claim 11, wherein the aggregator organizes the channel metadata and the annotation metadata for presentation and navigation using the metadata browser.

19. An electronic device, comprising:
a datastore on which channel content, a plurality of channel metadata items, and annotation metadata items are stored, each of the channel metadata items corresponding to a particular media file contained in the channel content; and
an aggregator instantiated on the electronic device that establishes a unique information space for a user and subscribes to at least one information feed identified by the user;
wherein the aggregator comprises a metadata browser that presents the channel metadata items and the annotation metadata items in a manner that indicates relationships between the channel content and the annotation metadata items, associates the channel metadata items with correlating annotation metadata items, indicates a relationship between the channel metadata items and annotation metadata items, and is used to browse the channel metadata items and the annotation metadata items.

20. The electronic device of claim 19, wherein:
responsive to a user selection of at least one of the annotation metadata items in the metadata browser, the electronic device loads an annotation content media file on a media player; and
responsive to a user selection of at least one of the channel metadata items in the metadata browser, the electronic device loads a corresponding channel content media file on the media player.
